(19) United States
(12) Patent Application Publication
(10) Pub. No.: US 2025/0079610 A1
(43) Pub. Date: Mar. 6, 2025

(54) SINGLE CELL BATTERY PACK PLATFORM

(71) Applicant: MILWAUKEE ELECTRIC TOOL CORPORATION, Brookfield, WI (US)

(72) Inventors: James Wekwert, Whitefish Bay, WI (US); Zachary G. Stanke, Wausau, WI (US); Gareth Mueckl, Milwaukee, WI (US); Christopher J. Kujawski, Menomonee Falls, WI (US); Daniel M. Blau, Milwaukee, WI (US)

(21) Appl. No.: 18/724,266

(22) PCT Filed: Jan. 3, 2023
(86) PCT No.: PCT/US2023/060012

§ 371 Date: Jun. 26, 2024

Related U.S. Application Data
(60) Provisional application No. 63/304,410, filed on Jan. 28, 2022.
(60) Provisional application No. 63/296,005, filed on Jan. 3, 2022.

(51) Int. Cl. H01M 50/247; B25F 5/02; H01M 50/284; H01M 50/55; H02K 7/14; H02K 9/06; H02K 11/00; H02K 11/33; H02K 21/16; H02K 21/22

(52) U.S. Cl. CPC H01M 50/247; B25F 5/02; H01M 50/284; H01M 50/55; H02K 7/145; H02K 9/06; H02K 11/0094; H02K 11/33; H02K 21/16; H02K 21/22; H01M 2220/30; H02K 2211/03

(57) ABSTRACT

A system including a power tool and a battery pack. The system includes a power tool including a housing. The housing includes a battery pack interface that includes a first battery pack terminal and a first retaining element. The power tool also includes an electric motor and a controller. The electric motor includes an inner stator, an outer rotor, and a fan. A battery pack includes a base, a stem, a second retaining element, and a single battery cell connected to a second battery pack terminal. The battery pack produces at least a 170 watt output. The stem of the battery pack is configured to be inserted into the battery pack interface of the power tool. The second retaining element is configured to engage the first retaining element. The controller is and configured to control power supplied from the second battery pack terminal to the electric motor.

### RELATED APPLICATIONS

This application claims the benefit of U.S. Provisional Patent Application No. 63/296,005, filed Jan. 3, 2022, and U.S. Provisional Patent Application No. 63/304,410, filed Jan. 28, 2022, the entire content of each of which is hereby incorporated by reference.

### SUMMARY

Single cell battery packs are desirable for a variety of applications because they provide the potential for miniaturization of form factors. However, conventional single cell battery packs are not capable of providing sufficient power for every desired application. For example, a conventional single cell battery pack might not be able to power a variety of handheld power tools in a desirable manner. Additionally, even if the single cell battery pack could power the handheld power tools as desired, miniaturization efforts may still be frustrated by a motor having adequate power, control circuitry, and efficiently passing power to the motor and control circuitry via a terminal of the battery pack.

Embodiments described herein provide a power tool. The power tool is a handheld power tool equipped with a motor, and is powered by a single cell battery pack. The power tool and single cell battery pack combination is capable of producing a maximum power tool output power of at least 170 watts.

Embodiments described herein provide a battery pack for a power tool. The battery pack includes a stem portion including a first and a second end, with a terminal disposed at a the first end and a base portion disposed at the second end. The battery pack includes a single battery cell connected to the terminal and configured to provide a maximum output power of at least 170 watts via the terminal. The battery pack further comprises a first retaining element configured to engage a second retaining element of a power tool.

Embodiments described herein provide a system including a power tool and a battery pack. The system includes a power tool including a housing. The housing includes a battery pack interface that includes a first battery pack terminal and a first retaining element. The power tool also includes an electric motor and a controller. The electric motor includes, for example, an inner stator, an outer rotor, and a fan. A battery pack includes a base, a stem, a second retaining element, and a single battery cell connected to a second battery pack terminal. The battery pack produces at least a 170 watt output. The stem of the battery pack is configured to be inserted into the battery pack interface of the power tool. The second retaining element is configured to engage the first retaining element. The controller is and configured to control power supplied from the second battery pack terminal to the electric motor.

Battery pack systems described herein include a power tool, a battery pack interface, a battery pack, and a controller. The power tool includes a housing and an electric motor. The electric motor includes an inner stator, an outer rotor, and a fan. The battery pack interface is disposed in the housing. The battery pack interface includes a first battery pack terminal and a first retaining element. The battery pack includes a base, a stem, a second retaining element, and a single battery cell connected to a second battery pack terminal. The stem is configured to be inserted into the battery pack interface of the power tool. The second retaining element is configured to engage the first retaining element. The controller is in electrical communication with the electric motor. The controller is configured to control power supplied from the first battery pack terminal and the second battery pack terminal to the electric motor.

In some aspects, the first battery pack terminal includes one of a male blade terminal and a female blade terminal, the second battery pack terminal includes the other of the male blade terminal and the female blade terminal, and the male blade terminal is configured to be inserted into the female blade terminal.

In some aspects, the electric motor is at least partially disposed within the housing of the power tool.

In some aspects, the outer rotor is configured to mechanically drive an output of the power tool.

In some aspects, the outer rotor of the electric motor has a diameter of 15 mm to 36 mm.

Battery pack described herein include a stem portion, a base portion, a terminal, a single battery cell, and a first retaining element. The stem portion includes a first end and a second end, and is configured to be inserted into a battery pack interface of a power tool. The base portion is disposed on the second end of the stem portion. The terminal is disposed at the first end of the stem portion. The single battery cell is connected to the terminal. The first retaining element is configured to engage a second retaining element of the power tool. The battery pack is configured to provide a maximum output power of at least 170 Watts via the terminal.

In some aspects, the battery cell has a nominal voltage between 3.6V and 4.2V.

In some aspects, the single battery cell is configured to be recharged via the terminal.

In some aspects, the base portion is substantially cylindrical with a base portion center width of 1.0 to 2.0 inches.

In some aspects, the stem portion is substantially cylindrical with a stem portion center width of 1.0 to 2.0 inches.

In some aspects, the first retaining element is a clip.

In some aspects, the terminal is a blade terminal.

In some aspects, the battery pack further includes a second blade terminal disposed at the first end of the stem portion.

Power tools described herein include a housing, a battery pack interface, a battery pack retaining element, and a terminal. The battery pack interface is configured to receive a battery pack. The battery pack interface includes an engagement groove. The engagement groove is configured to engage an engagement rail of the battery pack when the battery pack is inserted into the battery pack interface. The battery pack retaining element is disposed at an end of the battery pack interface. The battery pack retaining element is configured to retain the battery pack in the battery pack interface. The terminal is disposed at a terminal portion of the battery pack interface. The terminal is configured to electrically connect to the battery pack to receive power from the battery pack.

In some aspects, the housing includes a grip portion configured to be gripped by a user during use of the power tool when the battery pack is inserted into the battery pack interface. The grip portion is defined at least partially by the battery pack.

In some aspects, the battery retaining element is a battery retaining tab disposed at a bottom end of the battery pack interface and configured to engage bottom surface of the battery pack.

In some aspects, the power tool further includes the battery retaining element is a lever catch, and a retention lever of the battery pack includes a retention finger configured to engage the lever catch.

In some aspects, the terminal includes one or more blade terminals.

In some aspects, the terminal includes one or more sliding contact terminals.

In some aspects, the power tool further includes a peg configured to act as an engagement stabilization member. The peg is disposed at a top end of the battery pack interface. The peg is configured to be inserted into a cavity of the battery pack when the battery pack is inserted into the battery pack interface.

In some aspects, the power tool further includes an electric motor at least partially disposed within the housing.

In some aspects, the motor is an outer rotor motor.

In some aspects, the outer rotor motor has a diameter of 15 mm to 36 mm.

Before any embodiments are explained in detail, it is to be understood that the embodiments are not limited in application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1 illustrates a single cell battery pack having sliding electrical contact terminals, according to embodiments described herein.

FIG. 2 illustrates another view of the single cell battery pack having sliding electrical contact terminals of FIG. 1, according to embodiments described herein.

FIG. 3 illustrates a battery cell included in the single cell battery pack of FIGS. 1-2, according to embodiments described herein.

FIG. 4 illustrates a single cell battery pack including male blade terminals, according to embodiments described herein.

FIG. 5 illustrates a top view of the battery pack of FIG. 4.

FIG. 6 illustrates a battery cell including female blade terminals, according to embodiments described herein.

FIG. 7 illustrates a top view of the battery pack of FIG. 6.

FIG. 8 illustrates a circuit diagram for a single cell battery pack, according to embodiments described herein.

FIG. 9 illustrates power tool configured to be powered by a single cell battery pack, according to embodiments described herein.

FIG. 10 illustrates a control system for the power tool of FIG. 9, according to embodiments described herein.

FIG. 11 illustrates an integrated printed circuit board for the power tool of FIG. 9, according to embodiments described herein.

FIG. 12 illustrates an inner rotor electric motor, according to embodiments described herein.

FIG. 13 illustrates a sectional view of the inner rotor electric motor of FIG. 12, according to embodiments described herein.

FIG. 14 illustrates an outer rotor electric motor, according to embodiments described herein.

FIG. 15 illustrates a sectional view of the outer rotor electric motor of FIG. 14, according to embodiments described herein.

FIG. 16 illustrates a ratchet power tool powered by a single cell battery pack, according to embodiments described herein.

FIG. 17 illustrates a screwdriver power tool powered by a single cell battery pack, according to embodiments described herein.

FIG. 18 illustrates a reciprocating saw power tool powered by a single cell battery pack, according to embodiments described herein.

FIG. 19 illustrates a rotary power tool powered by a single cell battery pack, according to embodiments described herein.

FIG. 20 illustrates a drill power tool powered by a single cell battery pack, according to embodiments described herein.

FIG. 21 illustrates an impact driver power tool powered by a single cell battery pack, according to embodiments described herein.

FIG. 22 illustrates a rotary knife tool powered by a single cell battery pack, according to embodiments described herein.

FIG. 23 illustrates a wire stripper power tool powered by a single cell battery pack, according to embodiments described herein.

FIG. 24 illustrates a power pliers tool powered by a single cell battery pack, according to embodiments described herein.

FIG. 25 illustrates a nut driver tool powered by a single cell battery pack, according to embodiments described herein.

FIG. 26 illustrates a clamp powered by a single cell battery pack, according to embodiments described herein.

FIGS. 27A, 27B, and 27C illustrate a single cell battery pack, according to embodiments described herein.

FIG. 28 illustrates a portion of a power tool handle, according to embodiments described herein.

FIG. 29 illustrates the battery pack of FIGS. 27A-27C slidably engaging the power tool handle of FIG. 28, according to embodiments described herein.

FIG. 30 illustrates the battery pack of FIGS. 27A-27C connected to the power tool handle of FIG. 28, according to embodiments described herein.

FIG. 31 illustrates a single cell battery pack, according to embodiments described herein.

FIG. 32 illustrates a portion of a power tool handle, according to embodiments described herein.

FIG. 33 illustrates the battery pack of FIG. 31 connected to the power tool handle of FIG. 32, according to embodiments described herein.

### DETAILED DESCRIPTION

Embodiments described herein provide a system including a power tool and a battery pack. The system includes a power tool including a housing. The housing includes a battery pack interface that includes a first battery pack terminal and a first retaining element. The power tool also includes an electric motor and a controller. The electric motor includes, for example, an inner stator, an outer rotor, and a fan. A battery pack includes a base, a stem, a second retaining element, and a single battery cell connected to a second battery pack terminal. The battery pack produces at least a 170 watt output. In some embodiment, the battery pack produces an output power of approximately 190 watts, or between 170 watts and 215 watts. The stem of the battery pack is configured to be inserted into the battery pack interface of the power tool. The second retaining element is configured to engage the first retaining element. The controller is configured to control power supplied from the second battery pack terminal to the electric motor.

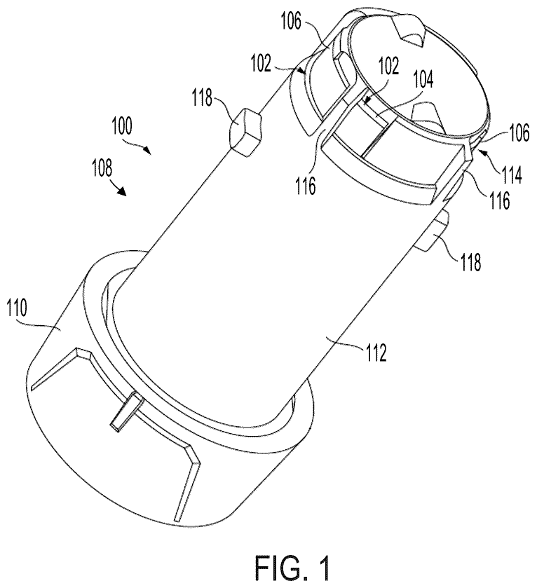

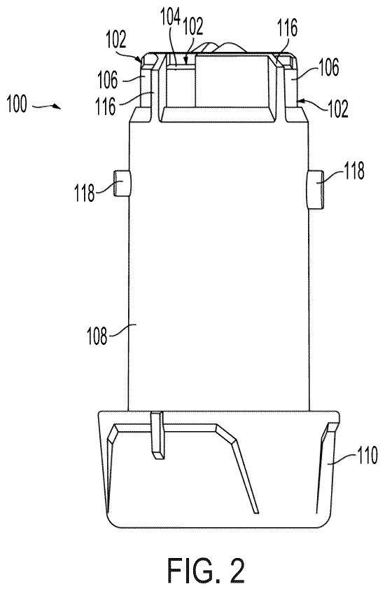

Although embodiments described herein can be applied to, performed by, or used in conjunction with a variety of high-power devices, embodiments are described primarily with respect to a battery pack and a device such as a power tool. FIGS. 1-2 illustrate a single cell battery pack 100 that includes sliding electrical contacts 102. Each of the sliding electrical contacts 102 includes a ramped portion 104 and a contact surface 106. The battery pack 100 further includes a housing 108 including a base portion 110 and a stem portion 112. In some embodiments, the center width or diameter of the base portion 110 and/or the stem portion 112 is between 1.0 in and 2.0 in. In some embodiments, the diameter of the base portion 110 is greater than the stem portion 112. An interface portion 114 is disposed at a first end of the stem portion 112 for connecting the battery pack 100 to a device such as a power tool. The battery pack 100 also includes tongues 116 on the interface portion 114. The tongues 116 are configured to ensure that the battery pack 100 properly connects to the device. The battery pack 100 further includes retaining elements 118 (e.g., notches) configured to engage retaining elements of the device (e.g., channels). The retaining elements 118 secure the interface portion 114 into electrical communication with the device via the sliding electrical contacts 102.

The battery pack 100 includes an internal battery cell connected to the sliding electrical contacts 102. The battery pack 100 is configured to be placed in mechanical and electrical connection with a device via the battery interface portion 114, to be retained in mechanical and electrical connection with the device by the retaining elements 118, and to provide power to the device from the single cell via the contact surfaces 106 of the sliding electrical contacts 102.

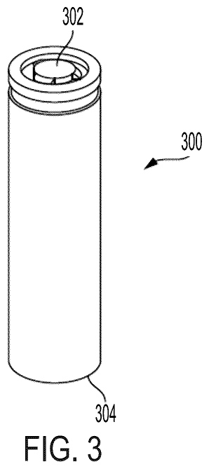

FIG. 3 illustrates a single lithium-based battery cell 300 having a positive terminal 302 and negative terminal 304. The single lithium-based battery cell 300 may be integrated into the battery pack 100 and configured to charge, discharge, and recharge via the sliding electrical contacts 102. The single lithium-based battery cell 300 may be, for example, a 4V, 4.0 Ah lithium-based battery cell and may be capable of producing a maximum output power of 441 watts (14.8 Wh of electrical energy). In some embodiments, the battery cell 300 has a nominal voltage of 3.6V-4.2V. In other embodiments, the battery cell 300 has a different voltage (e.g., 2-10V) and a different capacity (e.g., 2.0 Ah-10 Ah). In some embodiments, the battery cell 300 has a cylindrical diameter of approximately 21 mm, and a length of approximately 70 mm. In other embodiments, the battery cell 300 can have different dimensions, such as a cylindrical diameter of between 19 mm and 25 mm and a length of between 60 mm and 80 mm. In some embodiments, the battery cell 300 is constructed in a tables configuration. In some embodiments, the battery cell is a prismatic cell having a width of approximately 10-20 mm, a length of approximately 30-70 mm, and height of approximately 2-10 mm. Such a prismatic cell may have similar electrical properties to the cylindrical cells described above and may be used in the single cell battery pack disclosed herein. In some embodiments, a pouch cell (e.g., a lithium polymer pouch cell) is used in the disclosed battery pack and may be of similar size and electrical properties to those of the cylindrical and prismatic cells described above, and may likewise be used in the single cell battery pack disclosed herein.

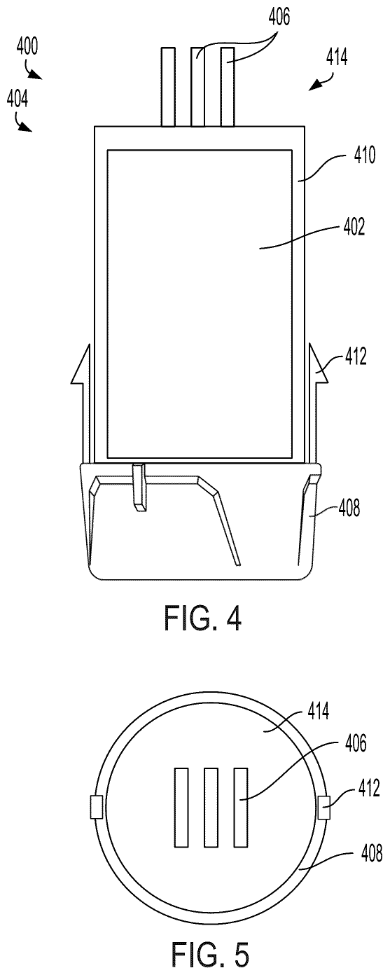

FIGS. 4-5 illustrate another single cell battery pack 400. Specifically, FIG. 4 illustrates a profile view of the battery pack 400, and FIG. 5 illustrates a top view of the battery pack 400. The battery pack 400 includes a single lithium-based battery cell 402 disposed in the battery housing 404 and blade terminals 406 (i.e., male blade terminals). The battery housing 404 includes a base portion 408 and a stem portion 410. In some embodiments, the center width or diameter of the base portion 408 and/or the stem portion 410 is between 1.0 in and 2.0 in. In some embodiments, the diameter of the base portion 110 is greater than the stem portion 112. The battery pack 400 further includes at least one retaining clip 412 extending from the base portion 408. Unlike the battery pack 100, the blade terminals 406 prevent the battery pack 400 from being rotated with respect to a device (e.g., a power tool). The retaining elements 412 are configured to be used in conjunction with the blade terminals 406 to secure the battery pack 400 to a device. An interface portion 414 is disposed at one end of the stem portion 410. The interface portion 414 includes the blade terminals 406, and is configured to facilitate an electrical connection between the battery pack 400 and a power tool via the blade terminals 406. The battery pack 400 is configured to be placed in mechanical and electrical connection with the power tool via the battery interface portion 414, to be retained in mechanical and electrical connection with the power tool by the retaining elements 412, and to provide power to the power tool from the single cell via the blade terminals 406. Although the battery pack 400 is shown has including 3 blade terminals 406, the battery pack 400 may have greater or fewer (e.g., 1, 2, 3, 4, 5, or more) blade terminals 406. The blade terminals have a lower resistance than other types of terminals (e.g., sliding electrical terminals). In some embodiments, the blade terminals have approximately 1 milli-Ohm or less terminal resistance. As a result, blade terminals (i.e., a male-female combination) produce significantly reduced (e.g., approximately 40% less) power losses compared to sliding electrical terminals.

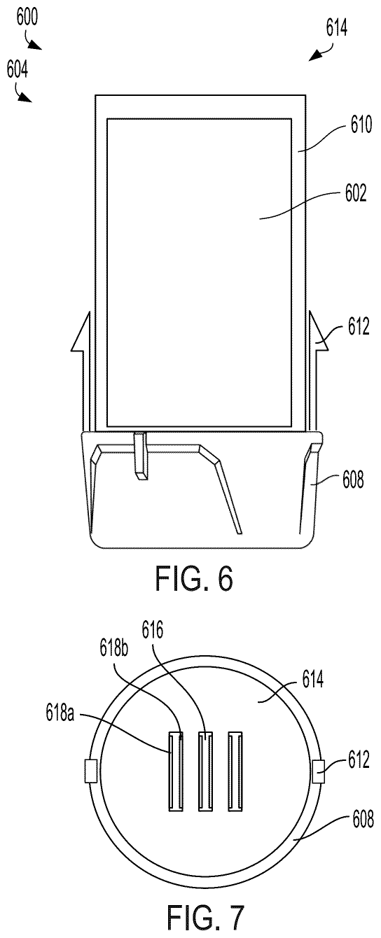

FIGS. 6-7 illustrate another single cell battery pack 500. Specifically, FIG. 6 illustrates a profile view of the battery pack 600, and FIG. 7 illustrates a top view of the battery pack 600. The battery pack 600 includes a single lithium-based battery cell 602 disposed in the battery housing 604. The battery housing 604 includes a base portion 608 and a stem portion 610. In some embodiments, the center width or diameter of the base portion 608 and/or the stem portion 610 is between 1.0 in and 2.0 in. In some embodiments, the diameter of the base portion 110 is greater than the stem portion 112. The battery pack 600 further includes retaining elements (e.g., clips) 612 extending from the base portion 608. An interface portion 614 is disposed at one end of the stem portion 610. The interface portion 614 includes female blade terminals 616, and is configured to facilitate an electrical connection between the battery pack 600 and a power tool via internal electrical contacts 618a, 618b of the female terminals 616 by mechanical contact and electrical connection with complementary male blade terminals of the power tool. The battery pack 600 is configured to be placed in mechanical and electrical connection with the power tool via the battery interface portion 614, to be retained in mechanical and electrical connection with the power tool by the retaining elements 612, and to provide power to the power tool from the single cell via the internal electrical contacts 618a, 618b of the female terminals 616. Although the battery pack 600 is shown has including 3 female blade terminals 616, the battery pack 600 may have greater or fewer (e.g., 1, 2, 3, 4, 5, or more female terminals 616). Unlike the battery pack 100, the female blade terminals 616 prevent the battery pack 600 from being rotated with respect to a device (e.g., a power tool). The retaining elements 612 are configured to be used in conjunction with the female blade terminals 616 to secure the battery pack 600 to a device.

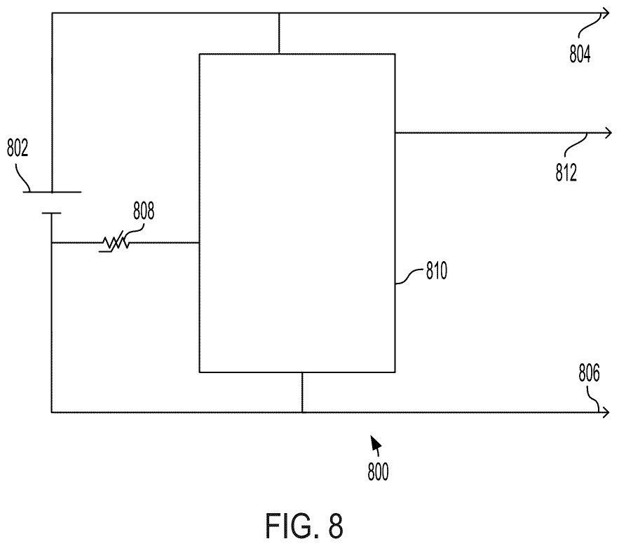

FIG. 8 illustrates a basic circuit diagram 800 for a single cell battery pack (e.g., battery pack 100, 400, 600). A single battery cell 802 is configured to produce current between terminals 804 and 806. In some embodiments, a sensor element 808 (e.g., a thermistor) is connected between the single battery cell 802 and a control element 810 (e.g., a microcontroller, a processor, an integrated circuit, etc.). The sensor element 808 probes a lead of the single battery cell 802 and produces an output signal that can be read by the control element 810. The control element 810 is configured to generate a control signal based on the output of the sensor element 808, and outputs the control signal on control line 812. For example, if the sensor element 808 is a thermistor, the thermistor produces temperature data readable by the control element 810. If the single battery cell 802 begins to overheat, the control element 810 may produce a control signal to disconnect the single battery cell 802 from an electrical circuit formed with a device (e.g., a power tool). In some embodiments, the battery pack 100, 400, 600 does not include a control element 810.

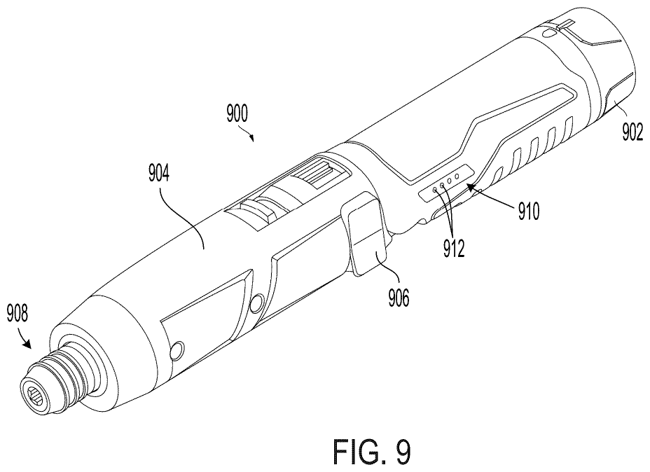

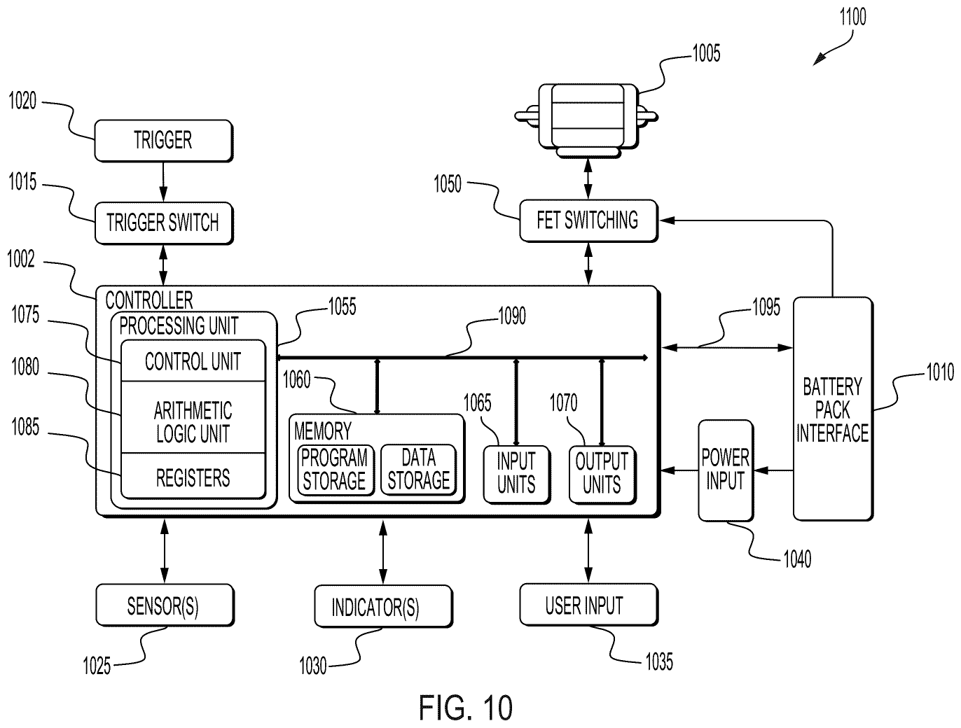

FIG. 9 illustrates an example handheld power tool 900 powered by a single cell battery pack 902 (e.g., battery pack 100, 400, 600). The battery pack 902 is inserted into a base of a housing 904 of the power tool 900. In some embodiments, 50% or more of the battery cell in the battery pack 902 is located outside of the tool body when the battery pack is connected to the power tool. In some embodiments, the entire battery cell in the battery pack is located outside of the tool body when the battery pack is connected to the power tool (e.g., so the power tool can be compatible with multiple different battery packs [e.g., 4V battery packs, two 4V battery packs, 8V battery packs, etc.]). A switch 906 of the power tool 900 is used to trigger a flow of current from battery pack 902 to an electric motor (see FIG. 10) of the power tool 900. The electric motor of the power tool 900 is configured to drive a mechanical output 908 of power tool 900 when excited by the current. A battery life indicator 910 is disposed along the housing 904 of the power tool 900. The battery life indicator 910 includes a plurality of indicator lights 912 configured to indicate the remaining life of the battery pack 902. In some embodiments, the power tool 900 combined with the battery pack 902 is capable of producing a maximum power tool output power of at least 130 W. In some embodiments, the power tool 900 combined with the battery pack 902 is capable of producing a maximum power tool output power of at least 140 W. In some embodiments, the power tool 900 combined with the battery pack 902 is capable of producing a maximum power tool output power of at least 150 W. In some embodiments, the power tool 900 combined with the battery pack 902 is capable of producing a maximum power tool output power of at least 160 W. In some embodiments, the power tool 900 combined with the battery pack 902 is capable of producing a maximum power tool output power of at least 170 W. In some embodiments, the power tool 900 combined with the battery pack 902 is capable of producing a maximum power tool output power of at least 170-180 W. The maximum output power of the tool corresponds to, for example, a power output of the battery pack 902 that corresponds to longer runtime, rather than a short duration burst of power (e.g., one or two seconds) or a transient power (e.g., from in-rush current). For example, the output power of the power tool 900 should be sustainable, for example, for 100 or more seconds.

As shown in FIG. 9, in some embodiments, the housing 904 of the power tool 900 includes plastic handle halves with bus bars or wire stampings insert molded into the handle halves to transfer power from a battery pack to the motor and electronics of the power tool 900 and/or to allow electrical communication with the electronics of the power tool 900. The above disclosures related to the power tool 900 can be applied to other power tools disclosed herein.

FIG. 10 illustrates a control system 1000 for the power tool 900. The control system 1000 includes a controller 1002. The controller 1002 is electrically and/or communicatively connected to a variety of modules or components of the control system 1000 and power tool 900. For example, the illustrated controller 1002 is electrically connected to a motor 1005, a battery pack interface 1010, a trigger switch 1015 (connected to a trigger 1020), one or more sensors or sensing circuits 1025, one or more indicators 1030, a user input module 1035, a power input module 1040, and a FET switching module 1050 (e.g., including a plurality of switching FETs). In some embodiments, the switching FETs or other switches for controlling the motor 1005 have a resistance (e.g., a drain-source resistance) of 0.5 milli-Ohms or less. The sensors 1025 can include a current sense resistor. In some embodiments, the current sense resistor has a resistance of 0.25 milli-Ohms or less, and associated wiring for powering the motor 1005 has a resistance of 1.0 milli-Ohms or less. The controller 1002 includes combinations of hardware and software that are operable to, among other things, control the operation of the power tool 900, monitor the operation of the power tool 900, activate the one or more indicators 1030 (e.g., an LED), etc.

The controller 1002 includes a plurality of electrical and electronic components that provide power, operational control, and protection to the components and modules within the controller 1002 and/or the power tool 900. For example, the controller 1002 includes, among other things, a processing unit 1055 (e.g., a microprocessor, a microcontroller, an electronic controller, an electronic processor, or another suitable programmable device), a memory 1060, input units 1065, and output units 1070. The processing unit 1055 includes, among other things, a control unit 1075, an arithmetic logic unit (“ALU”) 1080, and a plurality of registers 1085 (shown as a group of registers in FIG. 10), and is implemented using a known computer architecture (e.g., a modified Harvard architecture, a von Neumann architecture, etc.). The processing unit 1055, the memory 1060, the input units 1065, and the output units 1070, as well as the various modules or circuits connected to the controller 1002 are connected by one or more control and/or data buses (e.g., common bus 1090). The control and/or data buses are shown generally in FIG. 10 for illustrative purposes. The use of one or more control and/or data buses for the interconnection between and communication among the various modules, circuits, and components would be known to a person skilled in the art in view of the invention described herein.

The memory 1060 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 1055 is connected to the memory 1060 and executes software instructions that are capable of being stored in a RAM of the memory 1060 (e.g., during execution), a ROM of the memory 1060 (e.g., on a generally permanent basis), or another non-transitory computer readable medium such as another memory or a disc. Software included in the implementation of the power tool 900 can be stored in the memory 1060 of the controller 1002. The software includes, for example, firmware, one or more applications, program data, filters, rules, one or more program modules, and other executable instructions. The controller 1002 is configured to retrieve from the memory 1060 and execute, among other things, instructions related to the control processes and methods described herein. In other constructions, the controller 1002 includes additional, fewer, or different components.

The battery pack interface 1010 includes a combination of mechanical components (e.g., rails, grooves, latches, retaining elements, etc.) and electrical components (e.g., one or more male or female blade terminals) configured to and operable for interfacing (e.g., mechanically, electrically, and communicatively connecting) the power tool 900 with a battery pack (e.g., the battery pack 100, 400, 600). For example, power provided by the battery pack 100, 400, 600 to the power tool 900 is provided through the battery pack interface 1010 to the power input module 1040 (e.g., a power conditioning circuit). The power input module 1040 includes combinations of active and passive components to regulate or control the power received from the battery pack 600 prior to power being provided to the controller 1002. The battery pack interface 1010 also supplies power to the FET switching module 1050 to be switched by the switching FETs to selectively provide power to the motor 1005. The battery pack interface 1010 also includes, for example, a communication line 1095 for providing a communication line or link between the controller 1002 and the battery pack 100, 400, 600. In some embodiments, the battery pack interface 1010 is configured to receive two of the battery packs 100, 400, 600 in complementary interfaces such that the power tool 900 is an 8V power tool. In some embodiments, the battery pack 100, 400, 600 includes a housing configured to receive two of the battery cells 300. The battery pack 100, 400, 600 can include a communication line (see FIG. 8) to communicate with a power tool (e.g., indicating whether the pack is a 4V battery pack or an 8V battery pack). In some embodiments, the power tool is configured to determine whether the battery pack is a 4V battery pack or an 8V battery pack (e.g., based on a measured terminal voltage, a value of a resistor, etc.).

The indicators 1030 include, for example, one or more light-emitting diodes (“LEDs”). The indicators 1030 can be configured to display conditions of, or information associated with, the power tool 900. For example, the indicators 1030 are configured to indicate measured electrical characteristics of the power tool 900, the status of the power tool 900, the status of the battery pack 600, etc. The user input module 1035 is operably coupled to the controller 1002 to, for example, select a forward mode of operation or a reverse mode of operation, a torque and/or speed setting for the power tool 900 (e.g., using torque and/or speed switches), etc. In some embodiments, the user input module 1035 includes a combination of digital and analog input or output devices required to achieve a desired level of operation for the power tool 900, such as one or more knobs, one or more dials, one or more switches, one or more buttons, etc. In some embodiments, the indicators 1030 include the battery life indicator 910.

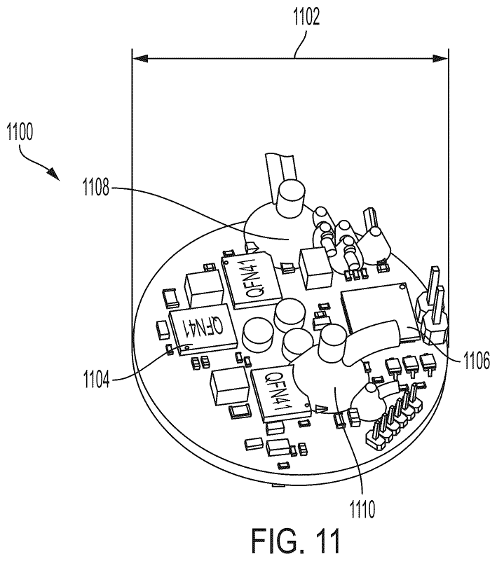

FIG. 11 illustrates an integrated circuit board 1100 for the power tool of FIG. 9. The integrated circuit board may include a power conditioning circuit, a motor control circuit, a lighting control circuit, data collection circuit, or any other circuit useful for the operation of power tool 900. The integrated circuit board 1100 has a circular form factor with a diameter 1102. The diameter 1102 is configured to be approximately the same diameter as the motor 1005, the battery pack stem portion 112, 410, 610, and/or the battery pack base portion 110, 408, 608. In some embodiments, the diameter 1102 of the integrated circuit board 1100 is between 18 mm and 26 mm. In some embodiments, the diameter 1102 is approximately 21 mm, 25 mm, 36 mm, or another suitable diameter sized to reduce the overall dimensions of the power tool 900. The integrated circuit board 1100 includes a number of FETs 1104, and microcontrollers 1106. The integrated circuit 1100 also includes a power inputs 1108 and 1110.

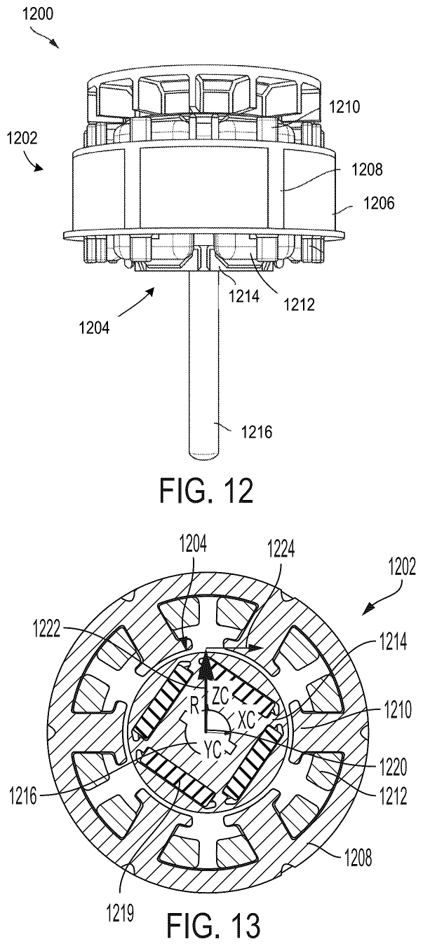

FIG. 12-13 illustrate an inner rotor electric motor 1200. Specifically, FIG. 12 illustrates a profile of the inner rotor electric motor 1200, and FIG. 13 illustrates a sectional view of the inner rotor electric motor 1200. The inner rotor electric motor 1200 comprises a stator 1202 surrounding the rotor 1204. The stator 1202 includes lamination stacks 1206 that are locked together by a pinning element 1208 and form stator teeth 1210. The stator teeth 1210 are wrapped by stator windings 1212. The rotor 1204 is positioned at the center of the stator 1202 and includes an armature 1214 and an output shaft 1216. The armature 1214 includes permanent magnets 1219 positioned around a rotational center 1220 of the output shaft 1216. A radius of rotation 1222 of the armature 1214 can be drawn from the rotational center 1220 of the output shaft 1216. A torque output of the inner rotor electric motor 1200 can therefore be determined based upon the radius of rotation 1222 multiplied by a force vector 1224 produced by electromagnetic forces of the stator 1202 on the permanent magnets 1219 of the armature 1214 during operation of the inner rotor electric motor 1200. In some embodiments, the outer diameter of the stator 1202 of the inner rotor electric motor 1200 is approximately 36 mm. In other embodiments, the outer diameter of the stator 1202 of the inner rotor electric motor 1200 has a value of between 25 mm and 36 mm. In some embodiments, the length of the stator is between approximately 35 mm and 60 mm. In some embodiments, the power tool 900 including the inner rotor electric motor 1200 and combined with the battery pack 902 is capable of producing a maximum power tool output power of between at least 150 W and 180 W.

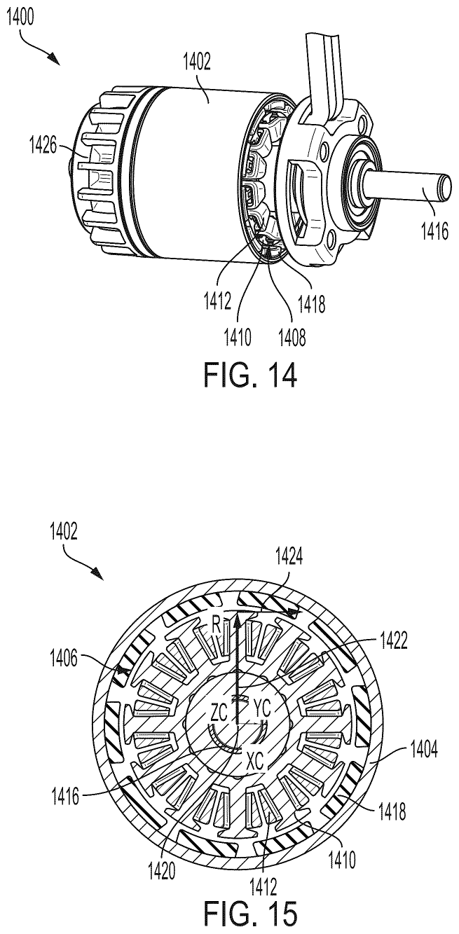

FIG. 14-15 illustrate an outer rotor electric motor 1400. Specifically, FIG. 14 illustrates a profile of the outer rotor motor 1400, and FIG. 15 illustrates a sectional view of the outer rotor electric motor 1400. The outer rotor electric motor 1400 includes a rotor 1402 with a hollow armature 1404 surrounding a stator 1406, the stator 1406 being positioned at the center of the hollow armature 1404. The stator 1406 includes lamination stacks 1408 that are locked together by a pinning element and form stator teeth 1410. The stator teeth 1410 are wrapped by stator windings 1412. The rotor 1402 includes an output shaft 1416 connected to the rotor 1402. The output shaft 1416 is configured to rotate with the rotor 1402. The rotor 1402 includes permanent magnets 1418 positioned around a rotational center 1420 of the output shaft 1416. A radius of rotation 1422 of the stator 1406 can be drawn from the rotational center 1420 of the output shaft 1416. As with the inner rotor electric motor 1200, a torque output of the outer rotor electric motor 1400 can be determined based upon the radius of rotation 1422 multiplied by a force vector 1424 produced by electromagnetic forces of the stator 1406 on the permanent magnets 1418 of the rotor 1402 during operation of the outer rotor electric motor 1400. A fan 1426 is positioned at one end of the outer rotor electric motor 1400 to help cool the outer rotor electric motor 1400 during operation. In some embodiments, the outer diameter of the rotor 1402 of the outer rotor electric motor 1400 is approximately 25 mm. In other embodiments, the outer diameter of the rotor 1402 of the outer rotor electric motor 1400 has a value of between 15 mm and 36 mm. In some embodiments, the length of the stator is between approximately 35 mm and 60 mm. In some embodiments, the power tool 900 including the motor 1400 and combined with the battery pack 902 is capable of producing a maximum power tool output power of between at least 130 W and 160 W.

In view of FIG. 13 and FIG. 15, the outer rotor electric motor 1400 having a comparatively smaller radius of rotation 1422 than the inner rotor electric motor 1200 can produce less power and less torque than the inner rotor electric motor 1200. However, the outer rotor electric motor 1400 allows for a more compact tool while still producing enough power to power a variety of power tools, as described below.

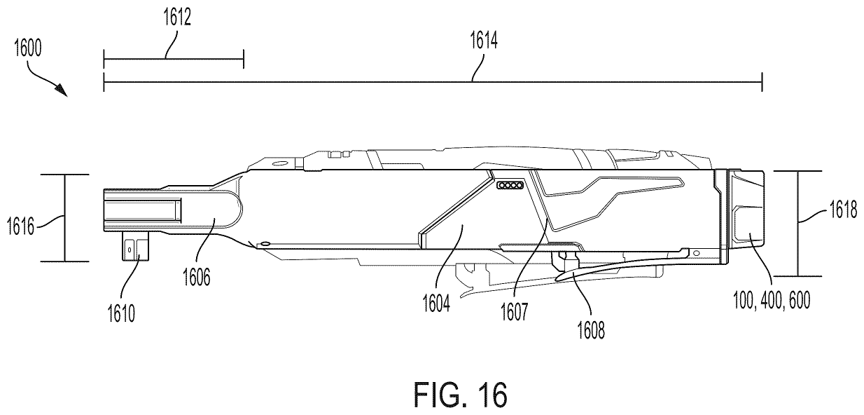

FIG. 16 illustrates a ratchet 1600 power tool powered by the battery pack 100, 400, 600. The ratchet 1600 includes a body 1604 and an output portion 1606. The battery pack 100, 400, 600 is inserted into a handle portion 1607 of the ratchet 1600, and powers, for example, the outer rotor electric motor 1400 connected to the output portion 1606 of the ratchet 1600 in response to a movement of a trigger 1608. The output portion 1606 is connected to a toolhead 1610 and is configured to affect a movement of the toolhead 1610. The width of the body 1604 is substantially the same width as the battery pack 100, 400, 600 and allows a user to comfortably grip the body 1604. In the example shown, the grip is between approximately 0.6 in to 1.5 in wide, and preferably substantially shares its width dimension with a dimension of the battery pack 100, 400, 600 and/or motor 1200, 1400. The body 1604 is roughly 9″ long, making the ratchet 1600 similar in size to an 8″ long air ratchet with a 5″ inch air hose fitting. Therefore, the ratchet 1600 can fit into and is useful in more locations and spaces than the air ratchet because the ratchet 1600 is not required to be connected to an air hose to function. Further, the length 1612 of the output portion 1606 is only about 20% of the total tool length 1614, meaning that 80% the ratchet 1600 is safe for gripping during operation. Additionally, the width 1616 of the output portion 1606 combined with the toolhead 1610 is about 80% of the width 1618 of the body 1604 combined with the trigger 1608.

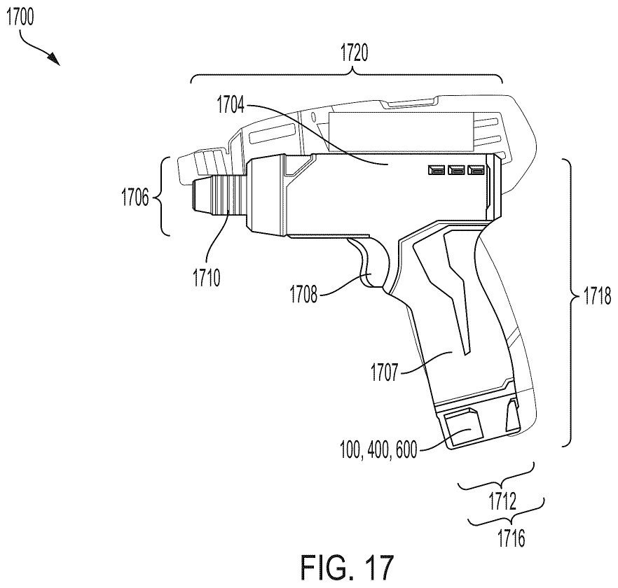

FIG. 17 illustrates a screwdriver 1700 power tool powered by the battery pack 100, 400, 600. The screwdriver 1700 includes a body 1704 and an output portion 1706. The battery pack 100, 400, 600 is inserted into a handle portion 1707 of the screwdriver 1700 and powers, for example, the outer rotor electric motor 1400 connected to the output portion 1706 of the screwdriver 1700 in response to a movement of a trigger 1708. The output portion 1706 is connected to a toolhead 1710 and is configured to affect a movement of the toolhead 1710. A width 1712 of the handle portion 1714 is substantially the same as the width 1716 of the battery pack 100, 400, 600. Additionally, the height 1718 of the screwdriver 1700 is approximately the same as the length 1720 of the screwdriver 1700 with the motor being disposed in the body 1704 and the battery pack 100, 400, 600 being disposed in the handle portion 1707, making the weight of the screwdriver evenly balanced. Specifically, this structure and weight distribution makes it easy for an operator to hold the screwdriver 1700 level during operation. In the example shown, the diameter of the body 1704 and/or the handle portion 1707 is between approximately 0.6 in to 1.5 in wide, and preferably substantially shares its width dimension with a dimension of the battery pack 100, 400, 600 and/or motor 1200, 1400.

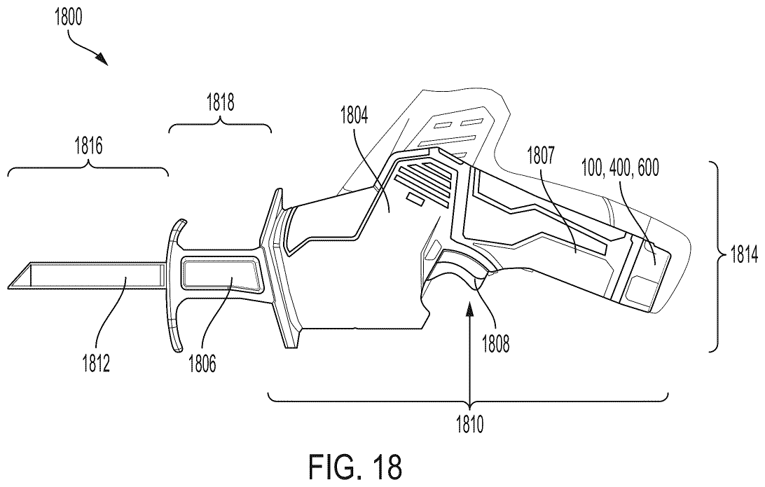

FIG. 18 illustrates a reciprocating saw 1800 power tool powered the battery pack 100, 400, 600. The reciprocating saw 1800 includes a body 1804 and an output portion 1806. The battery pack 100, 400, 600 is inserted into a handle portion 1807 of the reciprocating saw 1800 and powers, for example, the outer rotor electric motor 1400 connected to the output portion 1806 of the reciprocating saw 1800 in response to a movement of a trigger 1808. The output portion 1806 is connected to a toolhead 1812 and is configured to affect a movement of the toolhead 1812. The trigger 1808 is disposed about halfway along the length of the body 1804, with the outer rotor electric motor 1400 being disposed above the trigger 1808, and the battery pack 100, 400, 600 being disposed at least partially below the trigger 1808. A majority of the weight of the reciprocating saw therefore rests in or on an operator's hand during operation. This means that the toolhead 1812 (e.g., a blade) can be wielded lightly and is easy to maneuver during operation. The trigger 1808 is also located near the center point of the height 1814 of the reciprocating saw 1800, leading to additional maneuverability during operation. The length 1816 of the toolhead 1812 is about 120% the length 1818 of the output portion 1806. In the example shown, the diameter of the body 1804 and/or the handle portion 1807 is between approximately 0.6 in to 1.5 in wide, and preferably substantially shares its width dimension with a dimension of the battery pack 100, 400, 600 and/or motor 1200, 1400.

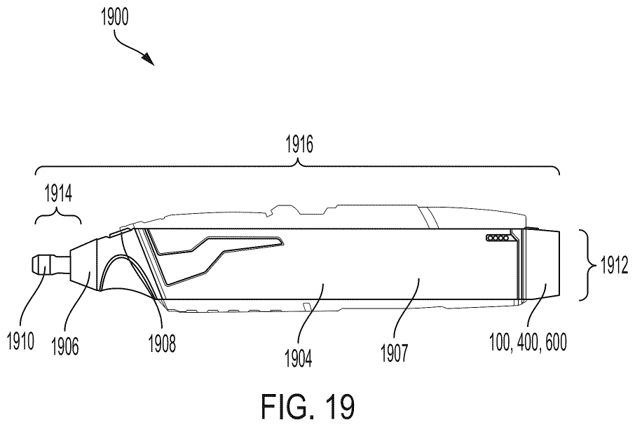

FIG. 19 illustrates a rotary power tool 1900 powered by the battery pack 100, 400, 600. The rotary power tool 1900 includes a body 1904 and an output portion 1906. The battery pack 100, 400, 600 is inserted into a handle portion 1907 of the rotary power tool 1900 and powers, for example, the outer rotor electric motor 1400 connected to the output portion 1906 of the rotary power tool 1900 in response to a movement of a switch or trigger 1908. The output portion 1906 is connected to a toolhead 1910 and is configured to affect a movement of the toolhead 1910. In the example shown, the diameter of the body 1904 and/or the handle portion 1907 is between approximately 0.6 in to 1.5 in wide, and preferably substantially shares its width dimension with a dimension of the battery pack 100, 400, 600 and/or motor 1200, 1400. Therefore, the rotary power tool 1900 can fit into and is useful in more locations and spaces than existing rotary tools. Additionally, the length 1914 of the output portion 1906 is about 15% the length 1916 of the body 1904.

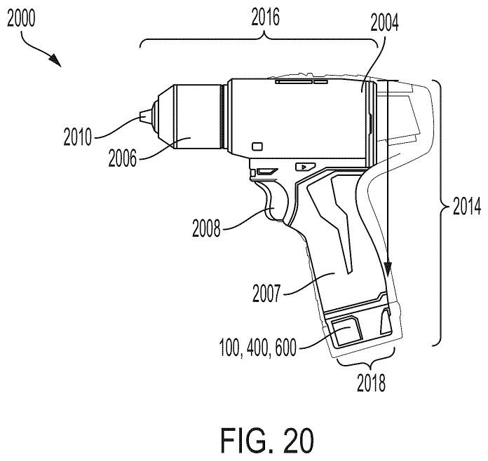

FIG. 20 illustrates a drill 2000 power tool powered by the battery pack 100, 400, 600. The drill 2000 includes a body 2004 and an output portion 2006. The battery pack 100, 400, 600 is inserted into a handle portion 2007 of the drill 2000 and powers, for example, the outer rotor electric motor 1400 connected to the output portion 2006 of the drill 2000 in response to a movement of a trigger 2008. The output portion 2006 is connected to a toolhead 2010 and is configured to affect a movement of the toolhead 2010. The handle portion 2007 of the drill 2000 extends out from under the body 2004 such that a wrist of an operator will not touch (or be positioned directly underneath) the body 2004 of the drill 2000 during operation. Additionally, the height 2014 of the drill 2000 is approximately the same as the length 2016 of the drill 2000 with the motor being disposed in the body 2004 and the battery pack 100, 400, 600 being disposed in the handle portion 2007, making the weight of the drill 2000 evenly balanced. Specifically, this structure and weight distribution makes it easy for an operator to hold the drill 2000 level during operation. In the example shown, the diameter of the body 2004 and/or the handle portion 2007 is between approximately 0.6 in to 1.5 in wide, and preferably substantially shares its width dimension with a dimension of the battery pack 100, 400, 600 and/or motor 1200, 1400.

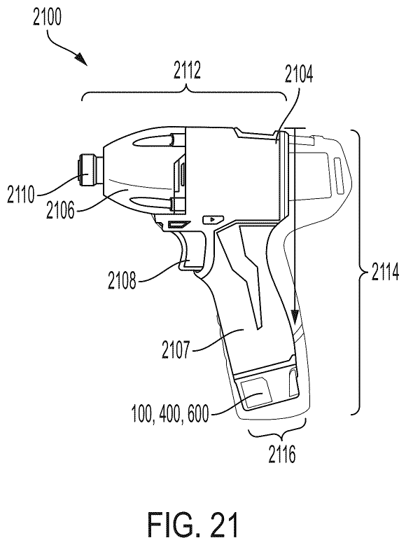

FIG. 21 illustrates an impact driver 2100 power tool powered by the battery pack 100, 400, 600. The impact driver 2100 includes a body 2104 and an output portion 2106. The battery pack 100, 400, 600 is inserted into a handle portion 2107 of the impact driver 2100 and powers, for example, the outer rotor electric motor 1400 connected to the output portion 2106 of the impact driver 2100 in response to a movement of a trigger 2108. The output portion 2106 is connected to a toolhead 2110 and configured to affect a movement of the toolhead 2110. The handle portion 2107 of the impact driver 2100 extends out from under the body 2104 such that a wrist of an operator will not touch (or be positioned directly underneath) the body 2104 of the impact driver 2100 during operation. The length 2112 of the body 2104 of the impact driver 2100 is less than the height 2114 of the impact driver 2100, increasing usability in tight spaces. In the example shown, the diameter of the body 2104 and/or the handle portion 2107 is between approximately 0.6 in to 1.5 in wide, and preferably substantially shares its width dimension with a dimension of the battery pack 100, 400, 600 and/or motor 1200, 1400.

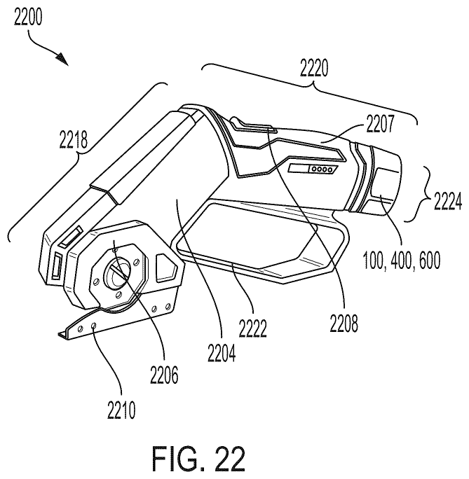

FIG. 22 illustrates a rotary knife 2200 tool powered by the battery pack 100, 400, 600. The rotary knife 2200 includes a body 2204 and an output portion 2206. The battery pack 100, 400, 600 is inserted into a handle portion 2207 of the rotary knife 2200 and powers, for example, the outer rotor electric motor 1400 connected to the output portion 2206 of the rotary knife 2200 in response to a movement of a switch or trigger 2208. The output portion 2206 is connected to a toolhead 2210 and is configured to affect a movement of the toolhead 2210. The handle portion 2207 of the rotary knife 2200 extends out from under the body 2204. Additionally, the length 2218 of the body 2204 of the rotary knife 2200 is approximately the same as the length 2220 of the handle portion 2207, with the motor being disposed in the body 2204 and the battery pack 100, 400, 600 being disposed in the handle portion 2207, making the weight of the rotary knife 2200 evenly distributed along the rotary knife 2200 and therefor making it easy for an operator to place even pressure on a guard 2222 of the rotary knife 2200 during operation. In the example shown, the diameter of the body 2204 and/or the handle portion 2207 is between approximately 0.6 in to 1.5 in wide, and preferably substantially shares its width dimension with a dimension of the battery pack 100, 400, 600 and/or motor 1200, 1400.

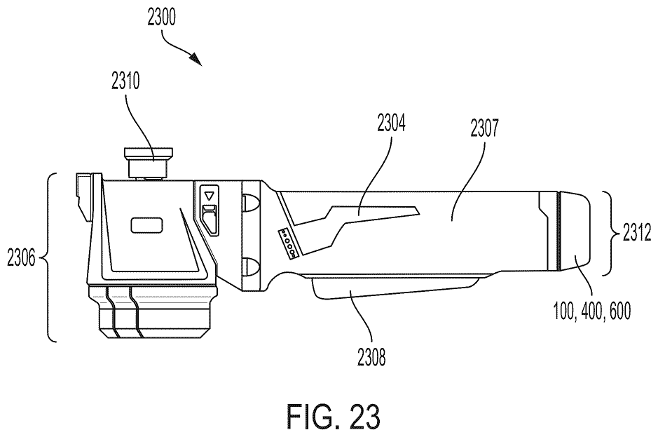

FIG. 23 illustrates a wire stripper 2300 power tool powered by the battery pack 100, 400, 600. The wire stripper 2300 includes a body 2304 and an output portion 2306. The battery pack 100, 400, 600 is inserted into a handle portion 2307 of the wire stripper 2300 and powers, for example, the outer rotor electric motor 1400 connected to the output portion 2306 of the wire stripper 2300 in response to a movement of a switch or trigger 2308. The output portion 2306 is connected to a toolhead 2310 and is configured to affect a movement of the toolhead 2310. In the example shown, the diameter of the body 2304 and/or the handle portion 2307 is between approximately 0.6 in to 1.5 in wide, and preferably substantially shares its width dimension with a dimension of the battery pack 100, 400, 600 and/or motor 1200, 1400. The output portion 2306 is roughly twice the width 2312 of the battery pack 100, 400, 600.

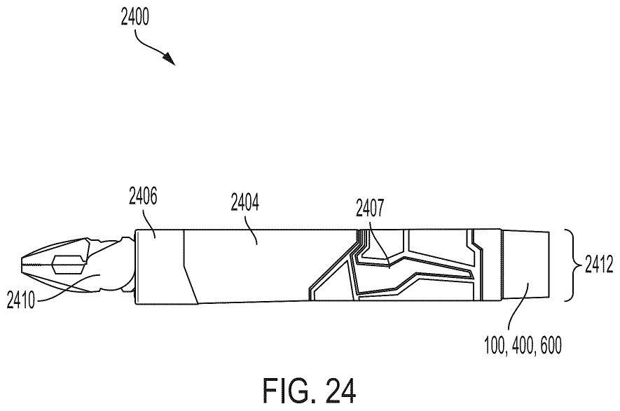

FIG. 24 illustrates a power pliers 2400 power tool powered by the battery pack 100, 400, 600. The power pliers 2400 includes a body 2404 and an output portion 2406. The battery pack 100, 400, 600 is inserted into a handle portion 2407 of the power pliers 2400 and powers, for example, the outer rotor electric motor 1400 connected to the output portion 2406 of the power pliers 2400 in response to a movement of a switch or trigger (not shown). The output portion 2406 is connected to a toolhead 2410 and configured to affect a movement of the toolhead 2410. In the example shown, the diameter of the body 2404 and/or the handle portion 2407 is between approximately 0.6 in to 1.5 in wide, and preferably substantially shares its width dimension with a dimension of the battery pack 100, 400, 600 and/or motor 1200, 1400. In some embodiments, the handle portion 2407 is substantially the width 2412 of the battery pack 100, 400, 600, making the power pliers 2400 smaller and more maneuverable than a standard set of manual pliers.

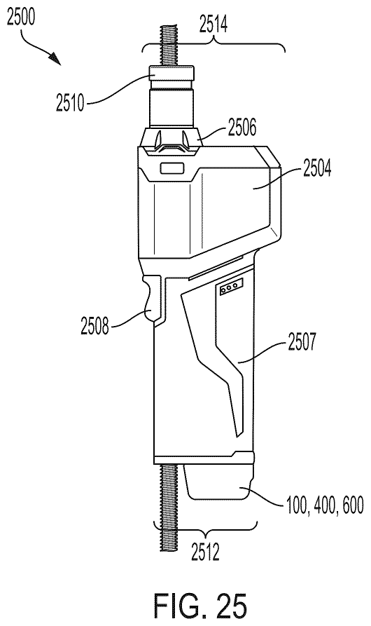

FIG. 25 illustrates a nut driver 2500 power tool powered by the battery pack 100, 400, 600. The nut driver 2500 includes a body 2504 and an output portion 2506. The battery pack 100, 400, 600 is inserted into a handle portion 2507 of the nut driver 2500 and powers, for example, the outer rotor electric motor 1400 connected to the output portion 2506 of the nut driver 2500 in response to a movement of a trigger 2508. The output portion 2506 is connected to a toolhead 2510 and is configured to affect a movement of the toolhead 2510. The width 2512 of the handle portion 2507 is about 60% of the width 2514 of the body 2504. In the example shown, the diameter of the body 2504 and the handle portion 2507 are between approximately 1.0 in to 2.5 in wide.

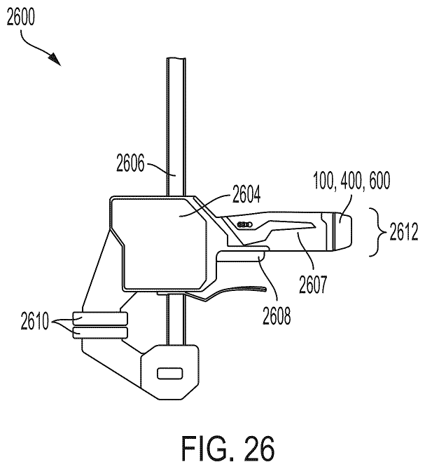

FIG. 26 illustrates a power clamp 2600 power tool powered by the battery pack 100, 400, 600. The power clamp 2600 includes a body 2604 and a clamp bar 2606. The battery pack 100, 400, 600 is inserted into a handle portion 2607 of the power clamp 2600 and powers, for example, the outer rotor electric motor 1400 connected to the clamp bar 2606 of the power clamp 2600 in response to a movement of a trigger 2608. The outer rotor electric motor 1400 moves the clamp bar 2606 up or down through the body 2604 in response to the movement of the trigger 2608, thereby causing the clamps 2610 to open or close. The handle portion 2607 is at a 90 degree angle to the clamp bar 2606, making it easy to use the power clamp 2600 to clamp an object to a board or flat surface by increasing the ergonomics of the power clamp 2600 over those of a standard manual clamp. In the example shown, the diameter of the handle portion 2607 is between approximately 0.6 in to 1.5 in wide, and preferably substantially shares its width dimension 2612 with a dimension of the battery pack 100, 400, 600 and/or motor 1200, 1400.

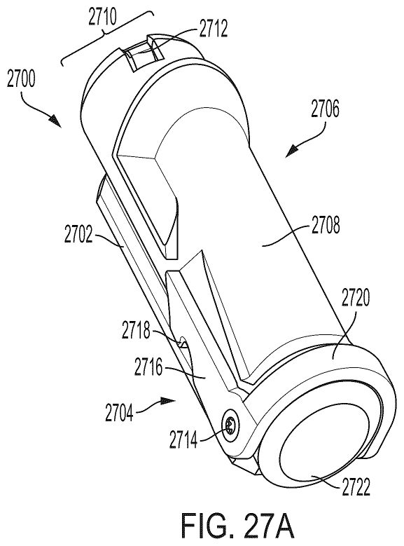

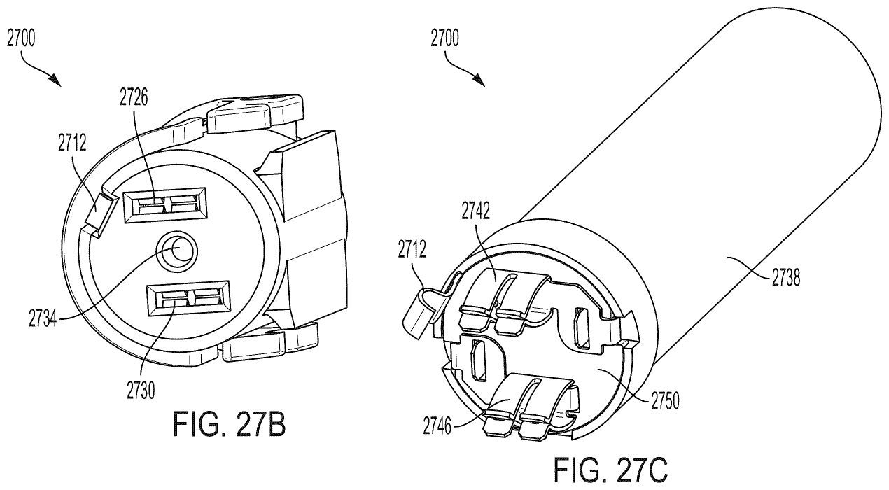

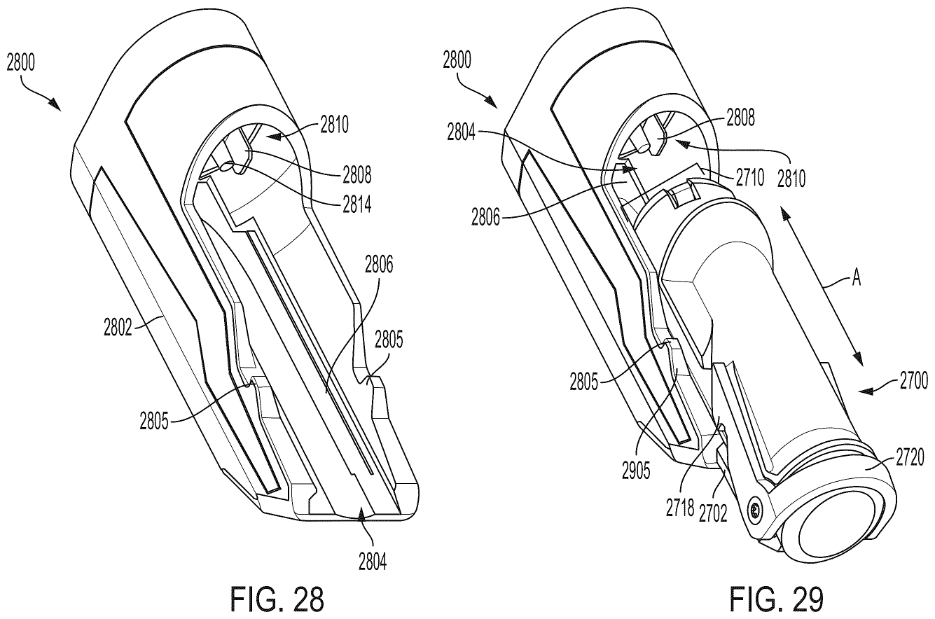

FIGS. 27A-27C illustrate a battery pack 2700 that is similar to the battery pack 400 described above, but including modified structural elements. The operational description of the battery pack 400 provided above is also applicable the battery pack 2700. The battery pack 2700 can similarly be used with power tools 1600, 1700, 1800, 1900, 2000, 2100, 2200, 2300, 2400, 2500, and 2600 when the power tools are modified for slidable engagement with the battery pack 2700 as described below. The battery pack 2700 includes an engagement rail 2702 and a retention lever 2704. The engagement rail 2702 is disposed on a backside of a body 2706 of the battery pack 2700, and is configured to slidably engage an engagement groove 2806 of a power tool (partially illustrated in FIG. 28). The body 2706 of the battery pack 2700 includes a grip portion 2708. A top portion 2710 of the battery pack 2700 includes a sliding contact terminal 2712, a first blade terminal (e.g., a first female blade terminal) 2726, and a second blade terminal (e.g., a second female blade terminal) 2730 (see FIGS. 27B and 27C). The power tool includes at least one corresponding blade terminal 2808 (e.g., a first male blade terminal) (see FIG. 28). The retention lever 2704 is configured to pivot about a pivot element 2714. In the embodiment shown, the pivot element 2714 is a screw attaching the retention lever 2704 to the body 2706 of the battery pack 2700, but the pivot element 2714 may take other forms (e.g., a notch on the body 2706 of the battery pack). The retention lever 2704 includes a lever arm 2716. The lever arm 2716 includes a retention finger 2718 configured to engage a lever catch 2805 (see FIG. 29) of the power tool. A lever release element 2720 is disposed on the retention lever 2704 and is configured to be rotated to a position under a bottom portion 2722 of the battery pack 2700 and thereby cause the retention lever 2704 to rotate to an open position where the battery pack 2700 can be slidably engaged or disengaged with a power tool.

FIG. 27B illustrates a top portion of the battery pack 2700 including the sliding contact terminal 2712, the first blade terminal 2726, the second blade terminal 2730, and a cavity 2734. FIG. 27C illustrates the battery pack 2700 with the body 2706 removed and a battery cell 2738 (as described above) and the terminals exposed. As illustrated in FIG. 27C, the first blade terminal 2726 includes a first pair of blades 2742, and the second blade terminal 2730 includes a second pair of blades 2746. In some embodiments, one or both of the first blade terminal 2726 and second blade terminal 2730 include a single blade 2742, 2746. The blades 2742, 2746 are connected to a printed circuit board (“PCB”) of the battery pack 2700.

FIG. 28 illustrates a portion of a power tool handle 2800 configured to receive the battery pack 2700. The power tool handle 2800 can, for example, be associated with any of power tools 1600-2600. The power tool handle 2800 includes a grip portion 2802 including a battery pack interface or a hollow battery pack accommodating portion 2804 and a lever catch 2805. The battery pack accommodating portion 2804 includes an engagement groove 2806. The engagement groove 2806 is configured to receive and engage the engagement rail 2702 of the battery pack 2700 when the battery pack 2700 is inserted into the battery pack accommodating portion 2804 of the power tool handle 2800. A male blade terminal 2808 is disposed at a terminal portion 2810 of the battery pack accommodating portion 2804, and is configured to electrically connect to the battery pack 2700 to draw power from the battery pack 2700. Although not shown, the terminal portion 2810 of this embodiment also includes a sliding terminal configured to electrically connect to sliding contact terminal 2712 of the battery pack 2700. The terminal portion 2810 of the battery pack accommodating portion 2804 also includes an engagement stabilization member 2814. In the embodiment shown, the engagement stabilization member 2814 is a peg configured to be inserted into the cavity 2734 (see FIG. 27B) disposed in the top portion 2710 of the battery pack 2700 when the battery pack 2700 is inserted into the battery pack accommodating portion 2804 of the power tool handle 2800. Although the battery pack 2700 is described as being connected to a power tool handle of a power tool, the battery pack 2700 can also be connected to a different portion of the power tool other than the handle.

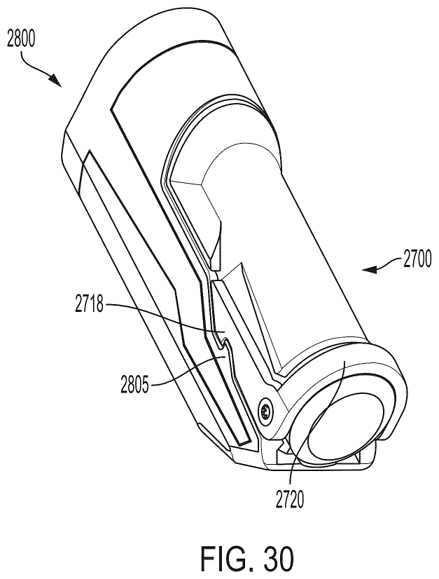

FIGS. 29-30 illustrate the insertion of battery pack 2700 into the power tool handle 2800, and the retention of the battery pack 2700 therein. In FIG. 29, the engagement rail 2702 is shown as sliding back and forth along engagement groove 2806, as illustrated by arrow A. During insertion of the battery pack 2700 into the battery pack accommodating portion 2804 of the power tool handle 2800, engagement rail 2702 slides along engagement groove 2806 toward the terminal portion 2810 of the battery pack accommodating portion 2804. As the battery pack 2700 slides toward the terminal portion 2810, retention finger 2718 slides up and over a ramped portion 2905 of lever catch 2805. As the top portion 2710 of the battery pack 2700 abuts the terminal portion 2810, the male blade terminal 2808 of the terminal portion 2810 is inserted into the female blade terminal (see FIGS. 27B and 27C) disposed in the top portion 2710 of the battery pack 2700 abutting the terminal portion 2810 of the power tool handle 2800. The retention finger 2718 drops behind lever catch 2805, retaining the battery pack 2700 in place. Thus, when the battery pack 2700 is fully inserted into the power tool handle 2800, the female terminal of the battery pack 2700 is placed in electrical communication with the male blade terminal 2808, and the retention finger 2718 of the retention lever 2704 engages the lever catch 2805, retaining the battery pack 2700 in place, as shown in FIG. 30. As also shown in FIG. 30, the battery pack 2700 inserted into power tool handle 2800 forms a power tool grip suitable for gripping during operation of the power tool.

In FIG. 29, it can also be seen that when the lever release element 2720 is depressed, and the retention finger 2718 is lifted, the battery may be removed from the battery pack accommodating portion 2804 by sliding the battery pack 2700 along engagement groove 2806 away from the terminal portion 2810 of the power tool handle 2800.

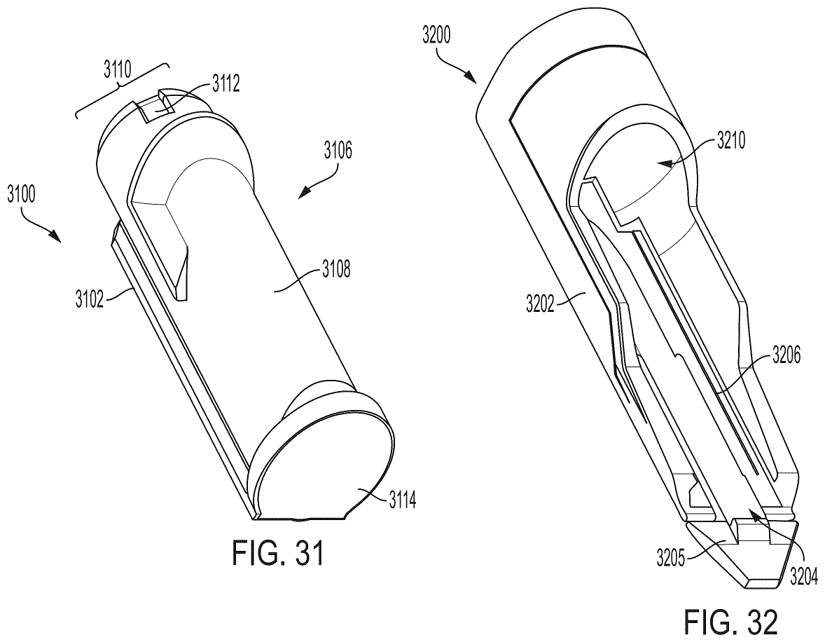

FIG. 31 illustrates a battery pack 3100 that is similar to the battery pack 400, 2700 described above, but including modified structural elements. The operational description of the battery pack 400 provided above is also applicable the battery pack 3100. The battery pack 3100 can similarly be used with power tools 1600, 1700, 1800, 1900, 2000, 2100, 2200, 2300, 2400, 2500, and 2600 when the power tools are modified for slidable engagement with the battery pack 3100 as described below. The battery pack 3100 includes an engagement rail 3102. The engagement rail 3102 is disposed on a backside of a body 3106 of the battery pack 3100, and is configured to slidably engage an engagement groove 3206 of a power tool (partially illustrated in FIG. 32). The body 3106 of the battery pack 3100 includes a grip portion 3108. A top portion 3110 of the battery pack 3100 includes at least one sliding contact terminal 3112. In some embodiments, the top portion 3110 of the battery pack 3100 substantially corresponds to the top portion 2710 of the battery pack 2700. In such embodiments, the battery pack 3100 will include the sliding contact terminal 3112, a first blade terminal, a second blade terminal, and a cavity similar to the blade terminals 2726, 2730 and cavity 2734.

FIG. 32 illustrates a portion of a power tool handle 3200 configured to receive the battery pack 3100. The power tool handle 3200 includes a grip portion 3202 including a hollow battery pack accommodating portion 3204 and a battery retaining tab 3205 configured to engage bottom surface 3114 (see FIG. 31) of the battery pack 3100. The grip portion 3108 of the battery pack 3100 and the grip portion 3202 of the power tool handle 3200 combine to define and form a grip portion for a power tool. As such, the grip portion is at least partially defined by the battery pack (e.g., the grip portion 3108). The battery pack accommodating portion 3204 includes an engagement groove 3206. The engagement groove 3206 is configured to receive and engage the engagement rail 3102 of the battery pack 3100 when the battery pack 3100 is inserted into the battery pack accommodating portion 3204 of the power tool handle 3200. A terminal is disposed at a terminal portion 3210 of the battery pack accommodating portion 3204 and is configured to electrically connect to the battery pack 3100 to draw power from the battery pack 3100. In some embodiments, the terminal portion 3210 is similar to the terminal portion 2810 of the power tool handle 2800 including the blade terminal 2808 and the engagement stabilization member 2814.

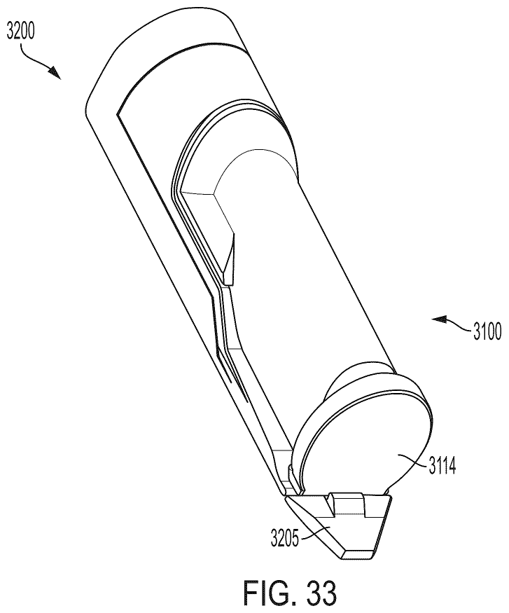

A portion of the battery retaining tab 3205 protrudes into the sliding path of the battery pack 3100 as it slides along engagement groove 3206. Pressure is therefore placed on battery retaining tab 3205 as the battery pack 3100 is being inserted into the battery pack accommodating portion 3204 of the power tool handle 3200. The battery retaining tab 3205 is mechanically biased against the battery pack 3100. When the battery pack 3100 is fully inserted into the power tool handle 3200, the terminal 3112 of the battery pack 3100 is placed in electrical communication with a terminal 2808 of the power tool, and a portion of the previously biased battery retaining tab 3205 snaps into place on the bottom surface 3114 under the fully inserted battery pack 3100, thereby retaining the battery pack 3100 in an inserted position, as shown in FIG. 33. To remove the battery pack 3100 from the battery pack accommodating portion 3204, the battery retaining tab 3205 is depressed to clear the bottom surface 3114, and any portion of the battery retaining tab 3205 retaining the battery pack 3100 in the inserted position is moved out of the way of engagement rail 3102. The battery pack 3100 may then be removed from the battery pack accommodating portion 3204 by sliding the battery pack 3100 along engagement groove 3206 away from the terminal portion 3210 of the power tool handle 3200. As shown in FIG. 33, the battery pack 3100 inserted into power tool handle 3200 forms a power tool grip suitable for gripping during operation of a power tool. Although the battery pack 3100 is described as being connected to a power tool handle of a power tool, the battery pack 3100 can also be connected to a different portion of the power tool other than the handle.

Although the power tools disclosed herein are described primarily as being configured to receive or accept a removable battery pack, it is contemplated that a battery may be integrated into a housing of the power tool. For example, a battery may be integrated into a handle of the power tool, and charging terminals for the integrated battery may also be disposed in the housing of the power tool (e.g., the handle), and be configured to accept a charging plug or charging terminals from a charger or charger base. The integrated battery may be a 4V, 4.0 Ah lithium-based battery cell (e.g., a cylindrical battery cell) and may be capable of produce a maximum output power of 441 watts (14.8 Wh of electrical energy). In some embodiments, a battery cell of the integrated battery has a nominal voltage of 3.6V-4.2V. In other embodiments, the battery cell has a different voltage (e.g., 2-10V) and a different capacity (e.g., 2.0 Ah-10 Ah). In some embodiments, the dimensions of the integrated battery are chosen for ergonomic purposes. For example, a flexible pouch battery may be chosen for integrating into a handle of the power tool so that the battery can be shaped to conform to and fit inside of a uniquely shaped portion of the power tool handle. In such a case, the charging terminal for the integrated battery may be located along the body (e.g., the handle) of the power tool.

It is also contemplated that the battery pack described herein may house and be used with multiple battery cell configurations (e.g., linear configurations, nested configurations, multi-row configurations, etc.)

Thus, embodiments described herein provide, among other things, a single cell battery pack platform. Various features and advantages are set forth in the following claims.

What is claimed is:

1. A battery pack system comprising:
a power tool including a housing and an electric motor, the electric motor including an inner stator, an outer rotor, and a fan;
a battery pack interface disposed in the housing, the battery pack interface including a first battery pack terminal and a first retaining element;
a battery pack including a base, a stem, a second retaining element, and a single battery cell connected to a second battery pack terminal, the stem configured to be inserted into the battery pack interface of the power tool, the second retaining element configured to engage the first retaining element; and
a controller in electrical communication with the electric motor, the controller configured to control power supplied from the first battery pack terminal and the second battery pack terminal to the electric motor.

2. The battery pack system of claim 1, wherein:
the first battery pack terminal includes one of a male blade terminal and a female blade terminal;
the second battery pack terminal includes the other of the male blade terminal and the female blade terminal; and
the male blade terminal is configured to be inserted into the female blade terminal.

3. The battery pack system of claim 1, wherein the electric motor is at least partially disposed within the housing of the power tool.

4. The battery pack system of claim 3, wherein the outer rotor is configured to mechanically drive an output of the power tool.

5. The battery pack system of claim 4, wherein the outer rotor of the electric motor has a diameter of 15 mm to 36 mm.

6. A battery pack comprising:
a stem portion including a first end and a second end, and configured to be inserted into a battery pack interface of a power tool;
a base portion disposed on the second end of the stem portion;
a terminal disposed at the first end of the stem portion;
a single battery cell connected to the terminal;
a first retaining element configured to engage a second retaining element of the power tool, and
wherein the battery pack is configured to provide a maximum output power of at least 170 Watts via the terminal.

7. The battery pack of claim 6, wherein the single battery cell has a nominal voltage between 3.6V and 4.2V.

8. The battery pack of claim 6, wherein the single battery cell is configured to be recharged via the terminal.

9. The battery pack of claim 6, wherein the base portion is substantially cylindrical with a base portion center width of 1.0 to 2.0 inches.

10. The battery pack of claim 9, wherein the stem portion is substantially cylindrical with a stem portion center width of 1.0 to 2.0 inches.

11. The battery pack of claim 7, wherein the first retaining element is a clip.

12. The battery pack of claim 7, wherein the terminal is a blade terminal.

13. The battery pack of claim 12, further comprising a second blade terminal disposed at the first end of the stem portion.

14. A power tool comprising:
a housing;
a battery pack interface configured to receive a battery pack, the battery pack interface including an engagement groove, the engagement groove configured to engage an engagement rail of the battery pack when the battery pack is inserted into the battery pack interface;
a battery pack retaining element disposed at an end of the battery pack interface, the battery pack retaining element configured to retain the battery pack in the battery pack interface; and
a terminal disposed at a terminal portion of the battery pack interface, the terminal configured to electrically connect to the battery pack to receive power from the battery pack.

15. The power tool of claim 14, wherein the housing includes a grip portion configured to be gripped by a user during use of the power tool when the battery pack is inserted into the battery pack interface, the grip portion defined at least partially by the battery pack.

16. The power tool of claim 14, wherein the battery pack retaining element is a battery retaining tab disposed at a bottom end of the battery pack interface and configured to engage bottom surface of the battery pack.

17. The power tool of claim 14, wherein:
the battery pack retaining element is a lever catch; and
a retention lever of the battery pack includes a retention finger configured to engage the lever catch.

18. The power tool of claim 14, wherein the terminal includes one or more blade terminals.

19. The power tool of claim 14, wherein the terminal includes one or more sliding contact terminals.

20. The power tool of claim 14, further comprising a peg configured to act as an engagement stabilization member, the peg disposed at a top end of the battery pack interface, the peg configured to be inserted into a cavity of the battery pack when the battery pack is inserted into the battery pack interface.

21. The power tool of claim 20, further comprising an electric motor at least partially disposed within the housing.

22. The power tool of claim 21, wherein the electric motor is an outer rotor motor.

23. The power tool of claim 22, wherein the outer rotor motor has a diameter of 15 mm to 36 mm.
